(19) United States
(12) Patent Application Publication
(10) Pub. No.: US 2010/0031079 A1
(43) Pub. Date: Feb. 4, 2010

(54) Restoration of a remotely located server

(75) Inventors: Ranjan K. Gupta, Salt Lake City, UT (US); Scott Alan Isaacson, Kamuela, HI (US); Kattiganehalli Y. Srinivasan, Princeton Junction, NJ (US)

Correspondence Address: KING & SCHICKLI, PLLC, 247 NORTH BROADWAY, LEXINGTON, KY, 40507, US

(73) Assignee: Novell, Inc.

(21) Appl. No.: 12/220,885

(22) Filed: Jul. 29, 2008

(51) Int. Cl. G06F 11/07

(52) U.S. Cl. 714/4; 714/E11.023

(57) ABSTRACT

Methods and apparatus restore data on servers in remote or branch offices utilizing virtual distribution components, such as virtual machines. A failed remotely located server is restored to its previous running state using any server with hardware compatible with the hardware of the failed server, rather than requiring a server with an exact copy of the hardware of the failed server. Virtual distribution components are configured without requiring a reimaging of the entire boot partition and physical distribution partition of a physical server. Application environment state information is restored without requiring a restoration of a full operating system state environment. Constantly supported interfaces of physical distribution components are utilized and a quick restoration of virtual distribution components results. Full system functionality is achieved more quickly than when a full physical system image restoration is required.

### FIELD OF THE INVENTION

Generally, the present invention relates to restoration systems for data on servers. Particularly, it relates to restoration systems for data on servers in remote or branch offices utilizing virtual distribution components, including virtual machines.

### BACKGROUND OF THE INVENTION

Many of today's enterprises have remote or branch offices that are geographically separated from a home office and corporate data center. As is typical, branch offices maintain local files and other items of interest, but to prevent redundancy and other concerns, connect to shared systems at the home office via server connections in the corporate data center. Among other things, these connections allow any of an enterprise's employees physically traveling to any of the branch offices to authenticate to and use the local computing resources without forcing a full synchronization of the entire corporate authentication and authorization model to the servers in the branch office. These connections also allow for a disconnected operation in the event of a network failure between a home office and a branch office.

Upon failure of a server in the branch office, recovery is presently undertaken by completely reimaging an entirely new server that has the exact same hardware as the failed server. Typically, but not necessarily, the new server is reimaged at the home office and then manually shipped to the branch office. In many instances, despite the shipping requirement, this approach is faster than reimaging and restoring over a network connection between the branch office and the corporate data center. For example, a two to three day turnaround of completely reimaged server from the home office has proven faster than trying to push hundreds of gigabytes of data through a 10 MB, or less, connection between the branch office and the home office.

Notwithstanding the above, completely reimaging an entirely new server has many disadvantages. For example, the reimaging of a full operating system and application environment must be completed which can be a slow and tedious process requiring, for instance, heavy computing and human resources. In addition, reimaging in this fashion requires a restoring state for both the operating system and the application environment thereby further expending resources. To the extent the new server is an exact hardware replica of the failed server, enterprise inventory and build-up costs are expended, which can decrease flexibility and increase the time necessary for restoration.

Accordingly, a need exists in the art of server restoration for a more flexible and less expensive restoration system. The need further contemplates a restoration system that operates at least as quickly and conveniently as the current server restoration methods, as well as a restoration system that expends less computing and human resources than the current methods. Naturally, any improvements along such lines should further contemplate good engineering practices, such as security, platform stability, ease of implementation, unobtrusiveness, etc.

### SUMMARY OF THE INVENTION

The above-mentioned and other problems become solved by applying the principles and teachings associated with the hereinafter-described restoration of a remotely located server. At a high level, methods and apparatus are provided that restore data on servers in remote or branch offices utilizing virtual distribution components, including virtual machines.

A restoration system utilizing virtual distribution components can restore a failed remotely located server to its previous running state using any server with hardware compatible with that of the failed server. The restored server may then be sent to the remote location of the failed server. Thus, a restoration system utilizing virtual distribution components does not require an exact copy of the hardware of the failed server for the restoration. In this respect, a restoration system utilizing virtual distribution components significantly increases flexibility and decreases expenses, including inventory carrying costs.

A restoration of a remotely located server using virtual distribution components also has the ability to restore application environment state information without requiring a restoration of a full operating system state environment. This ability is advantageous because application environment state information is often much smaller than a full operating system state environment. In other words, a restoration of only application environment state information increases the speed of the restoration and decreases the need for computing and human resources.

Further, virtual distribution components may be restored without requiring a reimaging of the entire boot partition and physical distribution partition of a physical server. Therefore, the amount of time, as well as computing and human resources, required to restore an application environment is reduced in a restoration of a remotely located server using virtual distribution components.

In addition, a restoration of a remotely located server using virtual distribution components relies on the constantly supported interfaces of physical distribution components and makes a quick restoration of virtual distribution components possible. That is, full system functionality is achieved more quickly than when a full physical system image restoration is required. For example, hardware similar to that on a remotely located server may be pre-staged with physical distribution components that are already running. Upon failure of the remotely located server, the pre-staged hardware is ready for the configuration of the virtual distribution components using the backup data from the remotely located server. Thus, a restoration administrator does not need to begin a restoration with non-staged hardware that is an exact copy of that of a remotely located server.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing system environment for a restoration of a remotely located server;

FIG. 2A is a diagrammatic view in accordance with the present invention of a representative remotely located server;

FIG. 2B is a diagrammatic view in accordance with the present invention of representative remotely located and restoration servers;

FIG. 3 is a flow chart in accordance with the present invention of a representative restoration of a remotely located server; and

FIG. 4 is a diagrammatic view in accordance with the present invention of a representative virtual architecture for a server.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for a restoration of a remotely located server are hereinafter described.

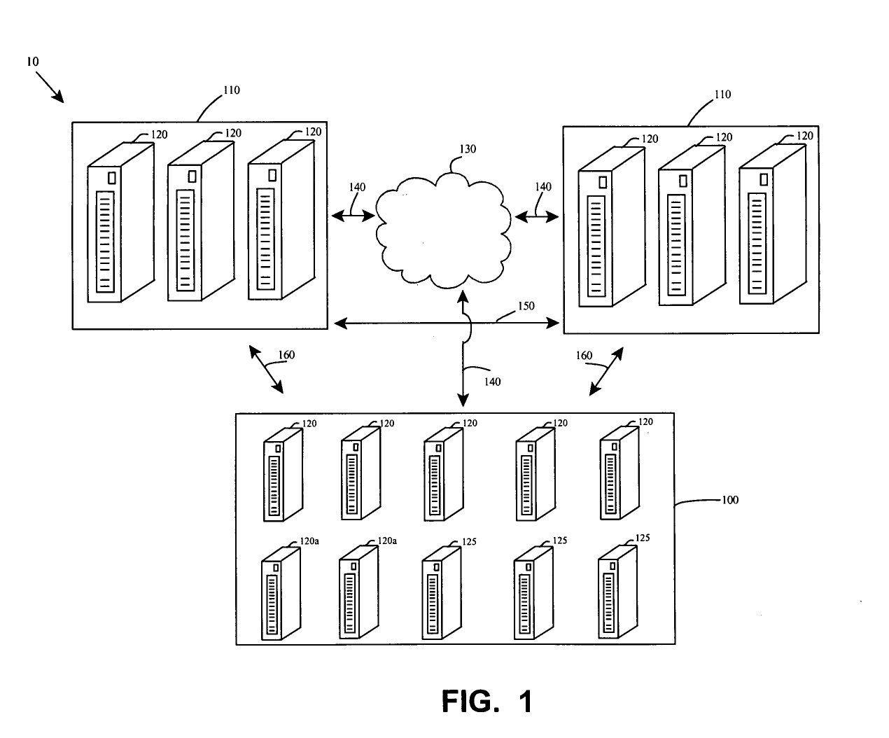

With reference to FIG. 1, a representative computing system environment 10 for a restoration of a remotely located server includes a main location 100 and one or more remote locations 110. The main location 100 and the remote locations 110 include one or more servers 120, such as grid or blade servers, fulfilling traditional server application roles such as web servers, e-mail servers, database servers, file servers, etc. The main location 100 also includes one or more restoration servers 125 that remain on standby until needed for the restoration of a failed server at a remote location 110. The restoration servers may also be pre-built/pre-configured to match a variety of remotely-located server architectures expected to fail in the future or are of a type that will be built/configured on-the-go, or are partially built/configured. In either event, the restoration servers will form the basis of those servers that restore data on servers in remote or branch offices and utilize virtual distribution components, including virtual machines. Naturally, other types of servers may also exist in the environment 10, such as backup servers 120a that fulfill the traditional role of redundancy.

In network, the locations 100 and 110 are arranged and communicate with one another as is typical nowadays between branch and remote offices. They may also communicate with other networks and computing devices (not shown). Further, skilled artisans will understand that nested hierarchies of one or more main locations 100 and remote locations 110 are possible. That is, a main location 100 and its attendant remote locations 110 may also serve as one of many satellite or regional locations to a higher, more-centralized headquarter main location, and a remote location 110 may also serve as a main location for still other remote locations (not shown). In another example, a national locations may serve as remote locations for a higher, international main location, etc.

To communicate, the locations 100 and 110 may use wired, wireless or combined connections, and may be direct connections 150 or 160, or indirect connections 140. If direct, they typify connections within physical or network proximity (e.g., intranet). If indirect, they typify connections such as those found with the internet, satellites, radio transmissions, or the like, and are given nebulously as element 130. In this regard, other contemplated items include servers, routers, peer devices, modems, T1 lines, satellites, microwave relays or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

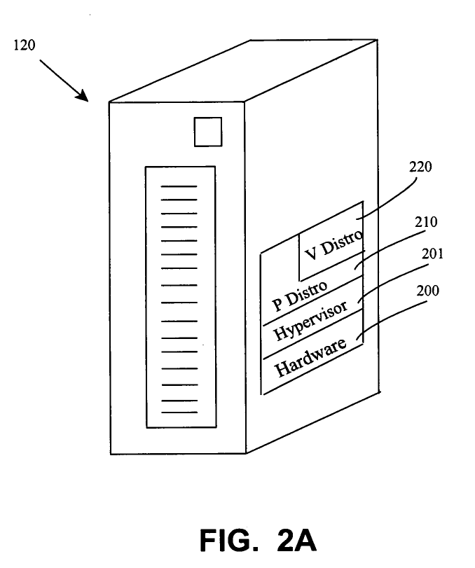

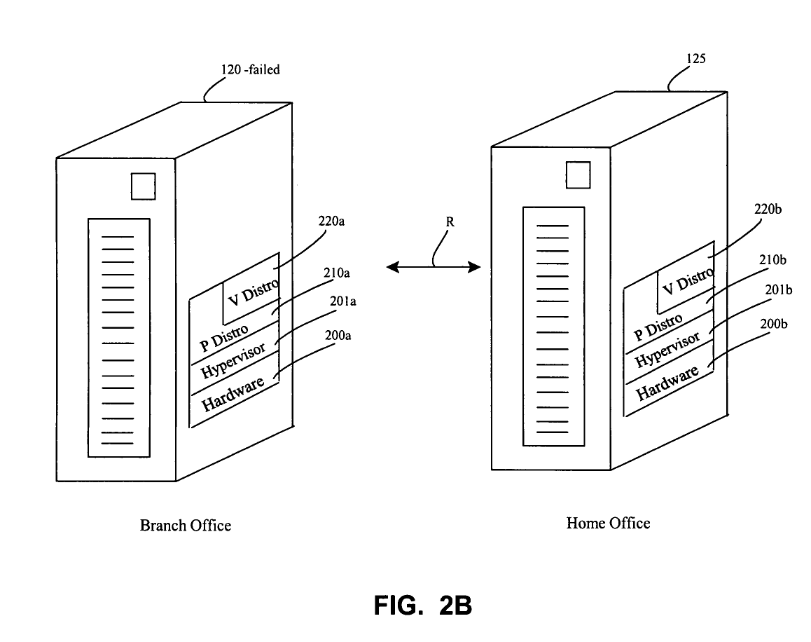

With the foregoing as backdrop, FIG. 2A illustrates a more detailed individual server 120 that is intended to be restored upon failure. Similarly, FIG. 2B illustrates the server in its failed condition (120-failed), at a remote location, and a restoration server 125 at the main location that is built/configured to replace the failed server. In either, each of these servers include hardware 200 representing the physical machine, a hypervisor 201 or other intermediary layer, and a physical distribution component 210 (pDISTRO) on the hypervisor, and one or more virtual distribution components 220 (vDISTRO) on the pDISTRO.

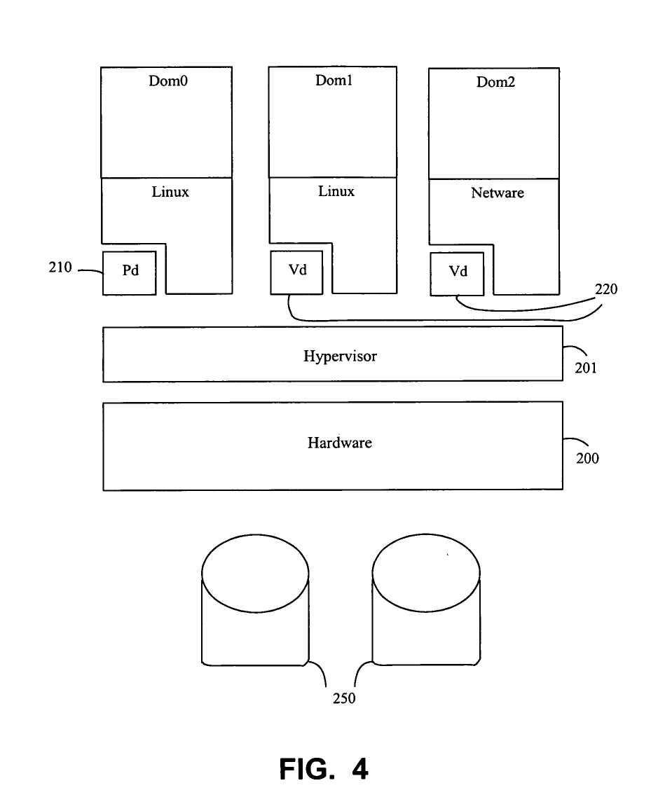

In slightly more detail, FIG. 4 shows a server arranged as a Xen architecture for Novell, Inc., (the assignee of the invention) including a multiplicity of domains (DOM) and a variety of operating systems (e.g., Linux and Netware). In turn, the various features representatively include: 1) hardware, which embodies physical 10 and platform devices, such as memory, a CPU, disk, USB, etc.; 2) a hypervisor, which is the virtual interface to the hardware (and virtualizes the hardware), and manages conflicts, for example, caused by operating system access to privileged machine instructions, it can also be type 1 (native) or type 2 (hosted); 3) pDISTRO, which is typically configured specifically for the hardware and used to deploy physical machine specific hypervisors with drivers, agents, sound cards, etc., needed by specific hardware vendors, and it may also include a file system or a directory service configured specifically for the hardware or a management function and a management interface; 4) vDISTRO which, may exist collectively on or in the pDISTRO, is used to deploy the virtual machines on the physical server and can move application stacks between them in real-time. (The virtual distribution components 220 may be customized and are typically optimized to support a dedicated workload. In this regard, each individual virtual machine may be configured with a different operating system. Also, the functionality of an individual virtual machine may be an application, shared service of the enterprise, or other known or later invented useful computing application(s). Of course, it is well known how a virtual machine can be configured and associated with virtual disks and content in the virtual disk and physical disks and content in the physical disk.); 5) DOM0, which is the management domain for Xen guests and dynamically undertakes control of computing resources, such as memory, CPU, etc., provides interface to the physical server, and provides various administration tools; and 6) DOM1 or DOM2, which hosts the application workloads per each virtual machine, including virtual device drivers which connect to the physical drivers in DOM0 by the hypervisor or physical device drivers in a direct fashion, and can be stored as a file image on remote or local storage devices 250. Of course, other arrangements are possible.

Turning back to FIG. 2B, the restoration of the failed remotely located server 120-failed is replaced by a restoration server 125 as seen by the action arrow R. Notably, however, the hardware 200a of the failed remotely located server and the hardware 200b of the restoration server 125 need not be identical for the restoration R to take place. Instead, by re-imaging the virtual machine of the failed server onto the restoration server using local, high-speed connections in the corporate data center, the restoration process can be greatly sped up and only certain capability requirements of the restoration server need to be satisfied, in order to fully restore the failed server.

For example, each of the failed server and the restoration server have hardware 200, including memory, processing unit(s), architecture, etc. To the extent the failed server had a 64-bit architecture, the restoration server could certainly have a 64-bit identical architecture for restoring the failed server, but could also have a wholly separate, non-identical architecture so long as it would accomplish the restoration task, e.g., a 128-bit architecture would satisfy the needs of a 64-bit architecture. In so doing, no longer is identical hardware required of the restoration server. In addition, the capability requirements for restoration may optionally be less than those actually used or needed by the failed remotely located server. For example, if the failed remotely located server had a specific storage capacity of 30 GB of memory, but only needed 20 GB of memory during use, a restoration server with only 25 GB of memory would satisfy the capability requirements every bit as well as a restoration server having an identical 30 GB of memory, or an amount more than the 30 GB of memory, such as 40 GB of memory. In this respect, a restoration using virtual distribution components overcomes the prior art problem of needing a restoration server with an identical copy of the hardware of the failed server. Of course, the determination for whether the restoration server has enough capability to satisfy the requirements of the failed server can be made via human or automated judgment, or both.

For the vDISTRO aspect of the restoration R, the vDISTRO(s) 220b of the restoration server 125 are configured with the backup state information of the vDISTRO 220a of the failed remotely located server 121. Typically, virtual machine orchestration services may be used for the restoration R, rather than the raw physical disk imaging of the prior art. For example, a cloned image of the virtual distribution components of the failed remotely located server may be configured on the restoration server, and skilled artisans understand its cloning (such as is regularly done in capturing base images of the vDISTRO at various times for purposes such as rollback, or for other reasons). The cloned image will also likely include an operating system for a particular domain, applications, any application data, etc. Thereafter, upon completion of the restoration R at the home office, the restoration server 125 is shipped to the remote location as before.

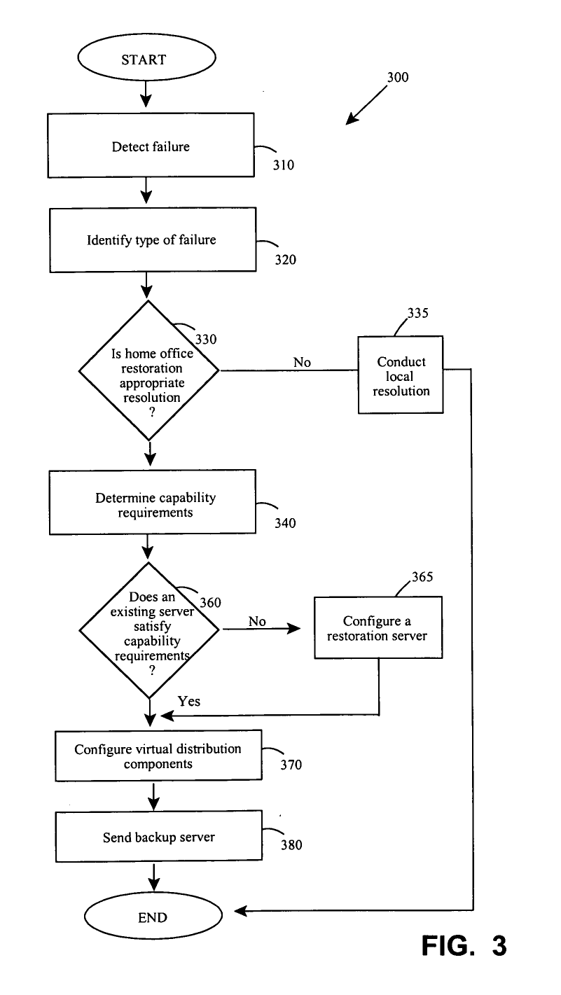

With reference to FIG. 3, a high-level diagram of the overall flow of a restoration of a remotely located server is given generically as 300. That is, a restoration is typically initiated in response to the detection of a failed server at a remote location, step 310. At 320, however, it may be first desirable to ascertain what type of failure has occurred in the remotely located server. For example, the failure in the remotely located server may be identified as one or more of a hardware failure, a software failure, a combined failure, etc. In turn, the failure may be graded or identified according to severity, such as whether the failure is a simple failure, a complex failure, a catastrophic failure, etc. Also, several different categories of failures may be sub-identified, such as whether a hardware failure is a memory failure, a CPU failure, etc., or whether a software failure is a failure of a particular application and on which virtual machines it occurred. Of course, skilled artisans will be able to contemplate other types and grades of failures.

Thereafter, at step 330, the identification of the type of failure can be used to assess whether a home-office restoration is an appropriate resolution to the identified failure or whether the resolution should be local, such as rebooting or re-installing a software program. In the event the restoration is determined to be a local restoration, step 335 provides for undertaking resolution locally and ending the process of restoration until such time as another failure is detected at step 310. On the other hand, if the restoration is determined to be more than the local office can handle, the home office undertakes the restoration beginning at step 340.

That is, the capability requirements to restore the failed server are determined. In certain embodiments, this includes determining requisite hardware in a restoration server that will meet/exceed those of the failed server, such as determining a minimum storage requirement, a minimum processing requirement, a minimum processing architecture, etc., as described earlier. It could also include, in certain embodiments, determining the capacities actually used or needed by the failed remotely located server, despite its actual configuration (e.g., consider the earlier example where the failed server had a specific storage capacity of 30 GB of memory, but only used 20 GB of memory, and a restoration server with only 25 GB of memory would satisfy the capability requirements, as would a restation with 40 GB of memory). In still other embodiments, this determination would contemplate pDISTRO requirements, such as whether performance settings were specifically configured for an operating system, such as LINUX, as opposed to NETWARE, WINDOWS, UNIX, etc. And, like other determinations, this determination can occur via humans, machines, executable code, etc.

At step 360, after determining the capability requirements for the restoration of the failed server, it is determined whether an existing restoration server on standby at the home office satisfies the capability requirements or whether a standby server will need to be configured/built for the purpose at hand. If an existing restoration server satisfies the capability requirements, the restoration continues to step 370. If, on the other hand, an existing restoration server does not satisfy the capability requirements, a restoration server that satisfies the capability requirements should be configured/built at step 365, before advancing to step 370. In practice, this includes modifying an existing server to conform to a given need, combining several servers to perform as a single server, adding or subtracting hardware, configuring an operating system, adding memory, or what ever task needs to be accomplished to make the restoration satisfy the needs of the failed server.

Regardless of whether a standby server had a pre-existing configuration satisfying the needs of the failed server, or whether a server needed to be configured on the fly, at step 370, the vDISTRO(s) of the restoration server are configured with the backup state information of the vDISTRO of the failed remotely located server. Representatively, this includes using virtual machine orchestration services, rather than the raw physical disk imaging of the prior art. As before, this might also mean placing a cloned image of the failed vDISTRO on the restoration server, and such may include an operating system, applications, application data, or the like.

Finally, at step 380, the restored server is sent to the remote location for replacement installation of the failed server, and such overcomes the stated problems of the prior art. Naturally, the restored server may be sent by way of overnight shipping services, by air, by land, by commercial or private couriers, etc.

Appreciating that enterprises can implement procedures with humans as well as computing devices, skilled artisans will understand that a restoration of a remotely located server may be managed by people, such as system administrators, as well as executable code, or combinations of each. As such, methods and apparatus of the invention further contemplate computer executable instructions, e.g., code or software, as part of computer program products on readable media, e.g., disks for insertion in a drive of computing device, or available as downloads or direct use from an upstream computing device. When described in the context of such computer program products, it is denoted that items thereof, such as modules, routines, programs, objects, components, data structures, etc., perform particular tasks or implement particular abstract data types within various structures of the computing system which cause a certain function or group of function, and such are well known in the art.

Ultimately, certain advantages of the invention over the prior art should now be readily apparent. For example, a remotely located server may be restored to its previous running state using any server that satisfies the specified capability requirements, rather than requiring a server with an exact copy of the hardware of the failed remotely located server. Therefore, a restoration system using virtual distribution components significantly increases flexibility and decreases expenses, including inventory carrying costs. In addition, the ability to restore application environment state information without requiring a restoration of a full operating system state environment increases the speed of the restoration. Further, a restoration of only virtual distribution components, rather than a reimaging of the entire boot partition and physical distribution partition of a physical server, reduces the amount of time, as well as human and computing resources, required to restore an application environment.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures or expanding the system to replicate the embodiments multiple times.

1. A method of restoring a failed remotely located server, comprising:
determining capabilities in a restoration server that will satisfy capabilities of the failed remotely located server without requiring hardware identical to the hardware of the failed remotely located server;
providing the restoration server meeting said determined capabilities; and
configuring virtual distribution components on the restoration server from an image of the virtual distribution components on the failed remotely located server.

2. The method of claim 1, further including identifying a type of failure in said remotely located server.

3. The method of claim 1, wherein said configuring virtual distribution components on the restoration server does not include re-imaging an entire boot partition of a physical entirety of the failed remotely located server.

4. The method of claim 1, further including sending said restoration server to a physical location of the failed remotely located server.

5. The method of claim 1, wherein said determining capabilities further includes determining a minimum storage requirement, a minimum processing requirement, or a minimum processing architecture of the failed remotely located server.

6. The method of claim 1, wherein said configuring virtual distribution components further includes configuring an operating system for a virtual machine, applications of the virtual machine, or application data of the applications.

7. A computer program product having executable instructions for performing the configuring step of claim 1.

8. A method of locally restoring a failed server of a remote location, comprising:
determining capabilities in a restoration server that will satisfy capabilities of the failed server without requiring hardware identical to the hardware of the failed server;
configuring the restoration server with said determined capabilities, including installing physical distribution components on said restoration server; and
configuring virtual distribution components on said restoration server using information about one or more virtual machines on the failed server.

9. The method of claim 8, further including identifying the type or severity of failure in said failed server.

10. The method of claim 9, wherein said identifying the type of failure further includes identifying said failure as a hardware failure or a software failure.

11. The method of claim 9, wherein said identifying the severity of failure further includes identifying said failure as a simple failure, a complex failure or a catastrophic failure.

12. The method of claim 8, further including sending said restoration server to a physical location of the failed server upon completion of the configuring virtual distribution components.

13. A method of locally restoring a server of a remote location, comprising:
identifying a failure in the server of the remote location;
determining whether the failure requires restoration at a central location away from the remote location;
if so, determining capabilities in a restoration server that will satisfy capabilities of the failed server without requiring hardware identical to the hardware of the failed server;
providing the restoration server with said determined capabilities, the providing occurring by either installing physical distribution components on said restoration server or utilizing an already-configured restoration server; and
configuring virtual distribution components on the restoration server from an image of the virtual distribution components on the server of the remote location.

14. The method of claim 13, wherein said determining capabilities further includes determining a minimum storage requirement, a minimum processing requirement, or a minimum processing architecture of the server of the remote location.

15. The method of claim 13, wherein said configuring virtual distribution components further includes configuring one of an operating system for a virtual machine, applications of the virtual machine, or application data from the applications.

16. A system for restoring a failed remotely located server, comprising:
a remotely located server, including a first hardware and first virtual distribution components;
a restoration server, including second virtual distribution components and a second hardware, wherein said second hardware is not identical to said first hardware; and
a restoration manager to configure said second virtual distribution components on said restoration server from an image of the first virtual distribution components.

17. The system of claim 16, wherein said restoration manager comprises executable instructions of a computing program product.

18. A computer program product available as a download or on a computer readable medium for loading on a computing device to ultimately assist in restoring a failed remotely located server, the computer program product having executable instructions, comprising:
a first component configured for determining capabilities in a restoration server that will satisfy capabilities of the failed server without requiring hardware identical to the hardware of the failed server; and
a second component configured for placing virtual distribution components on the restoration server from an image of virtual distribution components on the failed remotely located server.

19. The computer program product of claim 18, wherein the first component further includes configuration for determining one of a minimum storage requirement, a minimum processing requirement, or a minimum processing architecture of the failed remotely located server.

20. The computer program product of claim 18, wherein the second component further includes configuration for placing on the restoration server from the image one of an operating system for a virtual machine, applications of the virtual machine, or application data from the applications.
